(19) United States
(12) Patent Application Publication
(10) Pub. No.: US 2008/0035438 A1
(43) Pub. Date: Feb. 14, 2008

(54) Damping Device with Power-Assisted Deceleration and Use Thereof for the Damping of the Retractable Steering Column of a Motor Vehicle

(76) Inventor: Guy Valembois, Blagnac (FR)

Correspondence Address: EGBERT LAW OFFICES, 412 MAIN STREET, 7TH FLOOR, HOUSTON, TX, 77002, US

(21) Appl. No.: 11/568,699

(22) PCT Filed: May 11, 2005
(86) PCT No.: PCT/FR05/50314

§ 371 Date: Jun. 20, 2007

(30) Foreign Application Priority Data
May 11, 2004 (FR) 0450911

(51) Int. Cl. F16F 9/48; F16F 9/512

(52) U.S. Cl. 188/266.1; 188/284

(57) ABSTRACT

The invention relates to a damping device with power-assisted deceleration, which is intended to be used in the field of hydraulic shock dampers. The invention includes a sealed body filled with a hydraulic fluid and a piston mounted in the sealed body. The piston is connected to a rod axially movable outside the body. The rod and the body are arranged such that, while one is solidly connected to a support, an impact in relation to the other causes axial movement of the piston and compression of the fluid in a chamber. The invention also includes a flow mechanism for the hydraulic fluid to be released from the chamber and an element which can move axially inside the body to form a check valve that can seal the flow mechanism when pushed back in the opposite direction to that of the impact by an elastic device.

### BACKGROUND OF THE INVENTION

(1) Field of the Invention

The present invention relates to a damping device with power-assisted deceleration, for use in the field of the hydraulic shock absorbers.

(2) Description of the Prior Art

The hydraulic shock absorbers presently well-known allow controlling the stopping of an impacted object through causing a nearly constant deceleration of the latter. However, for a given design and size of the shock absorber, the level of deceleration varies according to the mass of said object, as well as according to its speed of impact.

Depending on the field of application involved, this feature can constitute a limit for the implementation of such a damping device.

This is the case, not restrictively, in the field of the elevators, the anti-collision systems, car building and namely as regards the steering columns.

Indeed, it is known that the steering wheel is a traumatizing obstacle for the driver in the event of a car accident. In order to improve the driver's safety, the car manufacturers have positioned an inflatable bag or “air bag” capable, in the event of frontal accident, of unfolding and intercalating itself between the steer wheel and the driver.

Some car manufacturers are increasingly providing a steering column likely to be partially withdrawn forwards at the time of the impact, thus allowing freeing a larger moving distance for the driver. In order to confer a real effectiveness to this concept, it is necessary for the collapse of the steering column to occur with a controlled force, which force is generated by the driver striking against the steering wheel via the air bag. This force allows managing the deceleration of the person through controlling his deceleration.

This deceleration should not be too strong, in order not to be seriously traumatizing, but neither should it be too slow, for the driver is then not “slowed down” enough and undergoes a violent impact at the end of the travel distance of the steering column.

The level of deceleration achieved during the collapse of the steering column is an essential parameter for controlling the non-lethality in the event of a car accident.

The car manufacturers are manufacturing steering columns which use shock absorbers such as those mentioned above, allowing adapting the dynamics of the column at the time of the accident with a controlled force, which optimizes the use of the travel distance of the column.

The deceleration induced by this damping force is however directly related to the mass of the individual striking the steering column: the acceleration is equal to the damping force decreased by the striking mass. Thus, the deceleration of a person of little weight is definitely higher than that of a person of higher weight.

Therefore, a steering column which is retracted under a constant force cannot provide the same level of safety for a whole population of different stoutness.

### SUMMARY OF THE INVENTION

The object of the present invention is to cope with the various above-mentioned disadvantages by providing a damping device with power-assisted deceleration allowing achieving a constant or nearly constant deceleration during the impact, irrespective of the mass and the speed of the impacting object, and which finds, non-restrictively, a particular application in the power-control of the dynamics of a retractable steering column.

According to the invention, the damping device with power-assisted deceleration, for use in the field of the hydraulic shock absorbers, is of the type comprising a sealed body filled with hydraulic fluid, in which is mounted a piston integral with a rod capable of being moved axially out of said body, said rod and said body being arranged so that a strike against one of them, while the other one is integral with a support, causes the axial displacement of the piston and the compression of said fluid in a chamber, and it is primarily characterized in that it comprises, on the one hand, flow means designed capable of allowing said hydraulic fluid to be released from said chamber and, on the other hand, an element which can move axially inside said body and which is designed capable of forming a check valve for closing said flow means when pushed back in the direction opposite to that of the impact by elastic means, said movable element being designed capable of being subjected to the initial speed of said impact, so that its displacement depends on its mass and on the compressive strength of said elastic means.

In use, the impact results into the displacement of the piston inside the body and the compression of the hydraulic fluid in the compression chamber, the initial speed of the impact is also communicated to the element forming a check valve and, since the latter is connected to the body only through the elastic means, it can, during deceleration, continue its displacement in the direction of the impact by compressing said elastic means, and thus allow a flow out of the chamber. This flow results into reducing deceleration, which causes the check valve to close, and so on.

The operation of the damping device according to the invention is thus in relation with the movement of the check valve, which movement depends only on the mass of the check valve and the compressive strength of the elastic means.

According to an additional feature of the device according to the invention, the piston delimits in the body two chambers, a first compression chamber for the fluid, and a second one for collecting the hydraulic fluid coming from said first chamber and proceeding from an escape provided for at the level of said piston.

The possibility of escaping at the level of the piston allows, during its displacement, a constant or nearly constant deceleration, before the intervention of the movable element forming a check valve.

According to another additional feature of the device according to the invention, the transverse dimensions of the portion of the body which delimits the compression chamber are decreasing in the direction of the displacement of the piston during the compression of said chamber.

According to another additional feature of the device according to the invention, the movable element forming a check valve has an annular or similar shape, and is pushed onto or into a part with a globally tubular shape which includes the means for the hydraulic fluid to flow out of the compression chamber, one of its edges being intended to come into contact with a portion of the body which forms the seat of said check valve.

According to another additional feature of the device according to the invention, the edge of the movable element forming a check valve, intended to come into contact with the seat, has on its face opposite that which seals the flow means, a chamfer conferring to said edge a whistle-like profile.

According to another additional feature of the device according to the invention, the means for the fluid to flow out of the compression chamber are associated with means allowing transferring the fluid flown out into the second chamber.

According to another particular embodiment of the device according to the invention, the means for the fluid to flow out of the compression chamber are arranged at the level of the piston.

According to a particular embodiment of the device according to the invention, the means for the fluid to flow out of the compression chamber are arranged at the level of the body.

The device according to the invention will advantageously find, but non-restrictively, a particular application in the field of the power-control of the damping of a retractable steering column of a motor vehicle.

To this end, according to the invention, the body is integral with the portion of the steering column movable with respect to the vehicle and the rod is integral with the vehicle, so that the displacement of said movable portion causes said rod to be extracted from said body, and the compression by the piston of the compression chamber which is designed capable, according to the position of the movable element with respect to the flow means, of allowing a flow of hydraulic fluid out of said body.

The advantages and the features of the device according to the invention will become clear from the following description, which refers to the attached drawing, which represents several non-restrictive embodiments of same.

### BRIEF DESCRIPTION OF THE DRAWINGS

In the attached drawing:

FIG. 1 represents a schematic and longitudinal cross-sectional view of a first embodiment of a damping device with power-assisted deceleration according to the invention.

FIG. 2 represents a schematic and longitudinal cross-sectional view of the same device in operation at the time of an impact.

FIG. 3 represents a schematic and longitudinal cross-sectional view of a variant of this same device.

FIGS. 4a and 4b represent schematic views of a portion of another variant of the same device.

FIG. 5 represents a schematic and longitudinal cross-sectional view of a second embodiment of the same device.

FIG. 6 represents a longitudinal cross-sectional view of a third embodiment of the same device, more particularly to be associated with a retractable steering column.

FIGS. 7a, 7b and 7c represent schematic and longitudinal cross-sectional views of the same device at different phases of its operation.

### DETAILED DESCRIPTION OF THE PREFERRED EMBODIMENTS

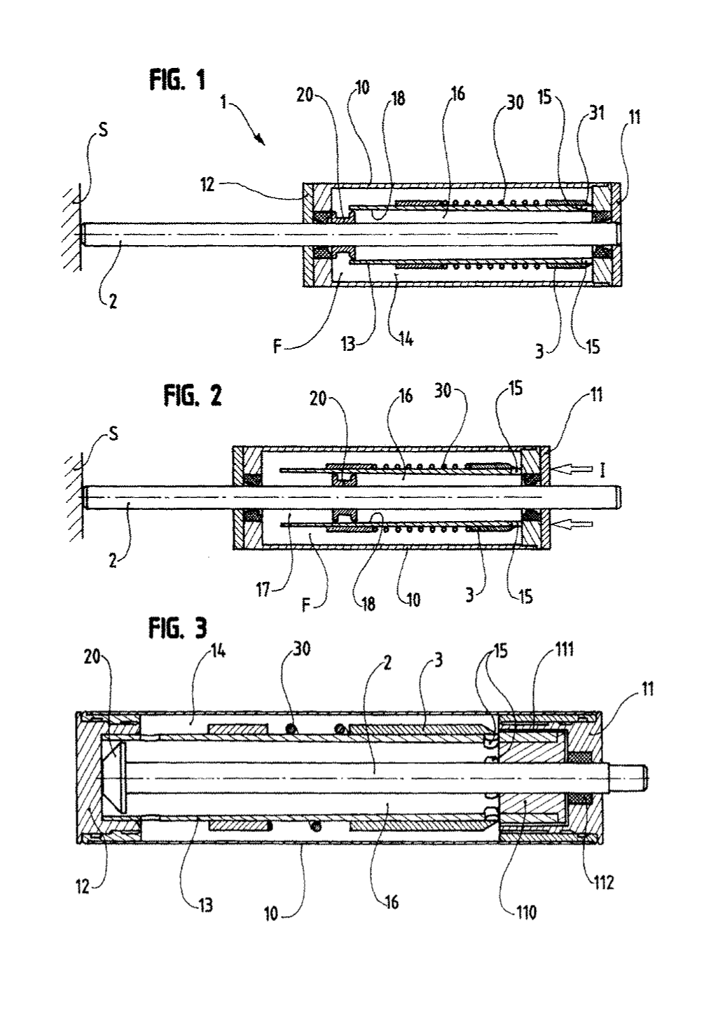

When referring to FIGS. 1 and 2, one can see a first embodiment 1 of a damping device with power-assisted deceleration according to the invention.

It includes a tubular body 10 closed at its two ends by two flanges 11 and 12, filled with a hydraulic fluid F, and which contains a tubular jacket 13 of reduced transverse dimensions so as to create a peripheral space 14.

The ends of the tubular jacket 13 are formed so as to allow a communication of the peripheral space 14 with the interior of the tubular jacket 13, which, on the side of the flange 11, occurs through radial holes 15.

Through the body 10 axially passes a rod 2 on which is clamped a piston 20 capable of longitudinally evolving in the tubular jacket 13 according to the displacement of the rod 2. The piston 20 divides the tubular jacket 13 into two chambers, a compression chamber or first chamber 16 on the side of the flange 11 and the holes 15, and a second chamber 17 on the other side, more particularly visible in FIG. 2.

It should be noted that the inner wall 18 of the tubular jacket 13 is not cylindrical, but evolutionary, i.e. its diameter is decreasing, linearly or not, towards the flange 11, so as to create a narrowing. This narrowing generates a hydraulic fluid escape between the piston 20 and the wall 18, escape whose flow rate is decreasing as the piston 20 approaches the flange 11.

Furthermore, the holes 15 are sealed by a sealing system comprising an annular element 3 which forms a check valve, inserted into the tubular jacket 13 on which it is slideably guided, pushed back against the flange 11 forming a seat, by a spring 30 also inserted onto the jacket tubular 13 and clamped onto the latter. The spring 30 is pre-stressed so that, in resting position, the annular element 3 closes the holes 15 and prevents any flow from the first chamber 16 into the peripheral space 14.

With reference in particular to FIG. 2, one can see that rod 2 is placed into abutment against a support S, while the body 10 is subjected to an impact I, or is integral with an object which is, in turn, subjected to this impact.

Under the impact I, the body 10 moves on the rod 2, and thus, relatively, the piston 20 moves in the tubular jacket 13, so as to compress the hydraulic fluid F in the first chamber 16. The narrowing allows, according to the relative insertion of the piston 20 into the first chamber 16, to gradually limit the flow between the piston 20 and the wall 18, thus to increase the pressure in the first chamber 16 and, hence, to slow down the displacement of the body 2.

This deceleration can be sufficient to cause the element 3 forming a check valve to move on the annular jacket 13 by compressing the spring 30. The displacement of the element 3 forming a check valve results into de-obstructing the holes 15, thus allowing the hydraulic fluid F to pass into the annular space 14 and thereby into the second chamber 17, with the result of a pressure drop in the first chamber 16 and a reduction of the deceleration.

This reduction of the deceleration causes, when it is sufficient, the sealing of the holes 15 by the element 3 forming a check valve, which creates an increase in pressure in the first chamber 16 and, thus, an increase in deceleration, and so on.

One can see that the operation is conditioned by the movement of the element 3 forming a check valve, if the mass of the latter is M and it is maintained by the spring 30 under a pre-stressing R, the movement of the element 3 in the opening direction can occur only under a deceleration of a value higher than the R/M ratio.

It should be noted that, advantageously, the outermost edge of the element 3 forming a check valve, intended to come into contact with the flange 11 forming a seat, has, outwardly, a chamfer 31 conferring it a whistle-like profile, allowing to create a singular pressure loss, which favors the closing of the element 3 forming a check valve.

Furthermore, it should be noted that the shape of the holes 15 is very important, since it can contribute to a modification of the flow characteristics and thus of the power-control. Indeed, during its movement in the direction of opening, the element 3 forming a check valve gradually opens the holes 15 and, according to the shape of the latter, the increase in flow rate is more or less progressive. Moreover, the element 3 forming a check valve opens the holes 15 starting with the portion part of the latter, and the shape of the latter influences the initial flow rate. Thus, the increase in flow rate is not the same when the holes are round, square, triangular or the like.

The choice of the shape of the holes can thus allow regulating the power-control.

When referring now to FIG. 3, one can see an exemplary construction of the device 1. One recognizes the tubular body 10, two flanges 11 and 12, the tubular jacket 13 and the peripheral space 14, the radial holes 15, the compression chamber 16, the rod 2 and its piston 20, the annular element 3 forming a check valve, and the pre-stressed spring 30.

In this mode of construction, the rod 2 only passes through the flange 11, which is associated with a guiding part 110 allowing to carry the rod 2 over a large distance, and which is arranged against the flange 11, on the inner side. In this example, the tubular jacket 13 consists of a tube intercalated between two flanges 11 and 12, and the part 110 is inserted into the end of the tube, on the side of the flange 11. It should be noted that, advantageously, there is provided, between the flange 11 and this end of the tube, for a passageway 111 allowing the hydraulic fluid F to reach the seal 112 of the flange 11, in order to protect this seal 112.

It should be noted that, advantageously, the passageway 111 ends into the peripheral space 14 where the hydraulic fluid F is never subjected to high pressure created by piston 20 during the impact, this also applies to the seal 112.

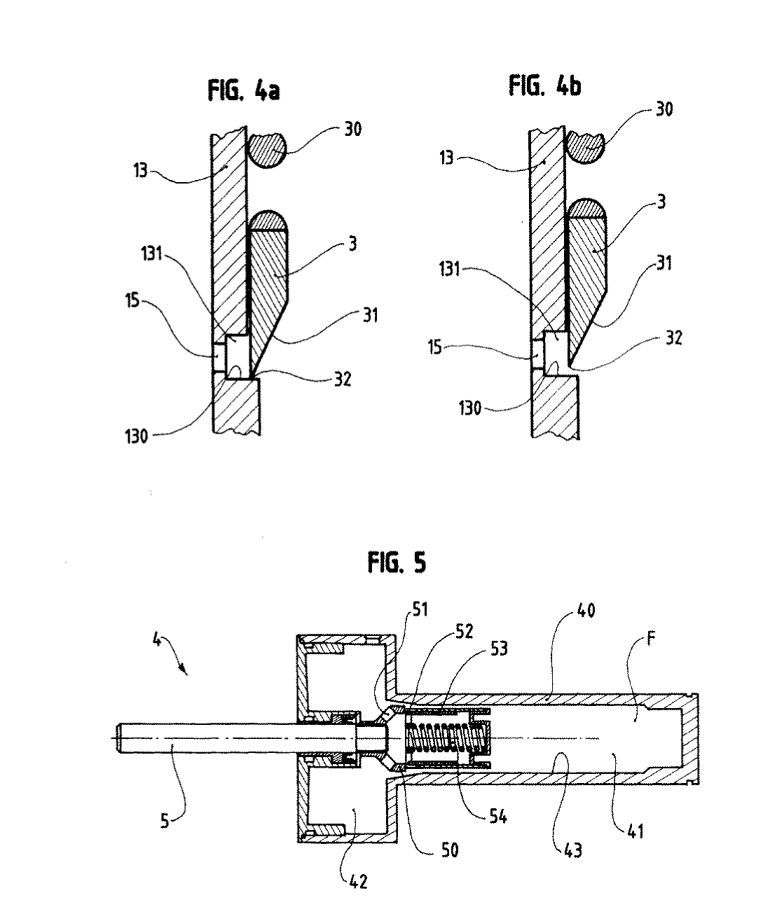

When referring now to FIGS. 4a and 4b, one can see a mode of manufacturing of the device according to the invention, and in particular as regards the element 3 forming a check valve, the tubular jacket 13 and the radial holes 15.

On the one hand, the jacket 13 has a difference in level, actually a difference in thickness, which creates a shoulder 130 aimed at forming the seat and, thus, at receiving the end 32 of the element 3 when the latter is brought back by the spring 30.

It should be noted that the device shown in FIG. 3 is made according to this mode of construction.

On the other hand, the jacket 13 peripherally includes, on the side of evolving of the movable element 3, a groove 131 on the bottom of which are provided for the holes 15, and one wall of which coincides with the shoulder 130.

This construction advantageously allows not to limit the flow of the fluid F to the diameter of the holes 15, since it can be carried out over the full periphery in the space provided between the shoulder 130 and the end 32 of the element 3 during the displacement of the latter, as can be seen in FIG. 4b.

When referring now to FIG. 5, one can see a second embodiment 4 of the device according to the invention. In this embodiment, contrary to the one shown in FIGS. 1 and 2 where the element forming a check valve is fitted on the body 10, one can see that it can be fitted on the piston.

This embodiment 4 comprises a body 40 filled with hydraulic fluid F, in which can move a rod 5 provided, at its one end, with a piston 50 which divides the inner space of the body 40 into a first chamber 41 and a second chamber 42.

The inner wall 43 of the body 4 at the level of the first chamber 41 has a narrowing so as to allow an escape of flow decreasing with the insertion of the piston 50.

The piston 50 includes, on the side of the second chamber 42, openings 51, as well as, peripherally on the side of the first chamber 41, openings 52, which are sealed by an annular element 53 forming a check valve, axially mobile and pushed back in the direction of closing by a spring 54, i.e. in the direction opposite the insertion of the piston 50 into the first chamber 41.

The operation of this device 4 is similar to that of the device 1, i.e. it is conditioned by the element 53 forming a check valve.

It should be noted that the features described in FIGS. 4a and 4b can also relate to this embodiment.

When referring now to FIG. 6, one can see a third embodiment 6 of the device according to the invention. This device 6 is associated with a system 7 of retractable steering column 70. This system 7 comprises supports 71 fixedly integral with the vehicle, in which can slide the steering column 70 for its retractability at the time of a violent impact applied to the steering wheel.

The device 6 comprises a body 60, which is in the form of a tubular jacket filled with hydraulic fluid F, limited on one side by a bottom 61 and on the other side by a flange 62, which will be described more in detail hereafter.

Through the flange 62 passes a rod 8 provided, at its end internal to the body 60, with a piston 80. As shown in FIG. 6, before operation, the rod 8 is drawn inside, the piston 80 is in contact with or in the vicinity of the bottom 61, and it delimits in the body 60, while authorizing some escape, a first chamber 63 between the latter and the flange 62 and, between the latter and the bottom 61, a second chamber 64, not yet existing in FIG. 6, since the piston 80 is in contact with the bottom 61.

The flange 62 has particular characteristics related to the fact that the device 6 should operate only once, and that the tightness must be guaranteed during the full life of the vehicle that is provided with it. To this end, it is manufactured without any dynamic part such as a seal.

The flange 62 thus comprises two parts that co-operate, namely a cylinder head 9 through which passes the rod 8, and a part 81 integral with the end of the rod 8, the cylinder head 9 and the part 81 being crimped onto the body 60 by means of a ring 65.

The part 81 comprises two portions, a peripheral portion 82 in the form of a disc, which is crimped by the ring 65, and a central portion 83 made integral with the end of the rod 8, these two portions 82 and 83 being connected by an area 84 of a lower resistance allowing, under some tensile force, to separate both portions 82 and 83.

The cylinder head 9 includes two portions, a peripheral portion 90 in the form of a disc, which is crimped by the ring 65, and a central portion 91, which has a tubular shape and extends in the body 60 and which is closed, on that side, by a bottom 92. The portions 90 and 91 are united by an intermediate area drilled with holes 93 authorizing the hydraulic fluid F to flow until the portion 81.

The portion 91 contains a tubular element 94 forming a check valve, pushed back through a spring 95 intercalated between the latter and the bottom 92, against the portion 81, or more exactly the peripheral portion 82 in the form of a disc of the latter, in order to seal the holes 93.

The device 6 is associated with the system 7 as follows, the body 60 is integral with the column 70, while the part 81 is maintained integral by its central portion 83 with the supports 71 fixedly integral with the vehicle.

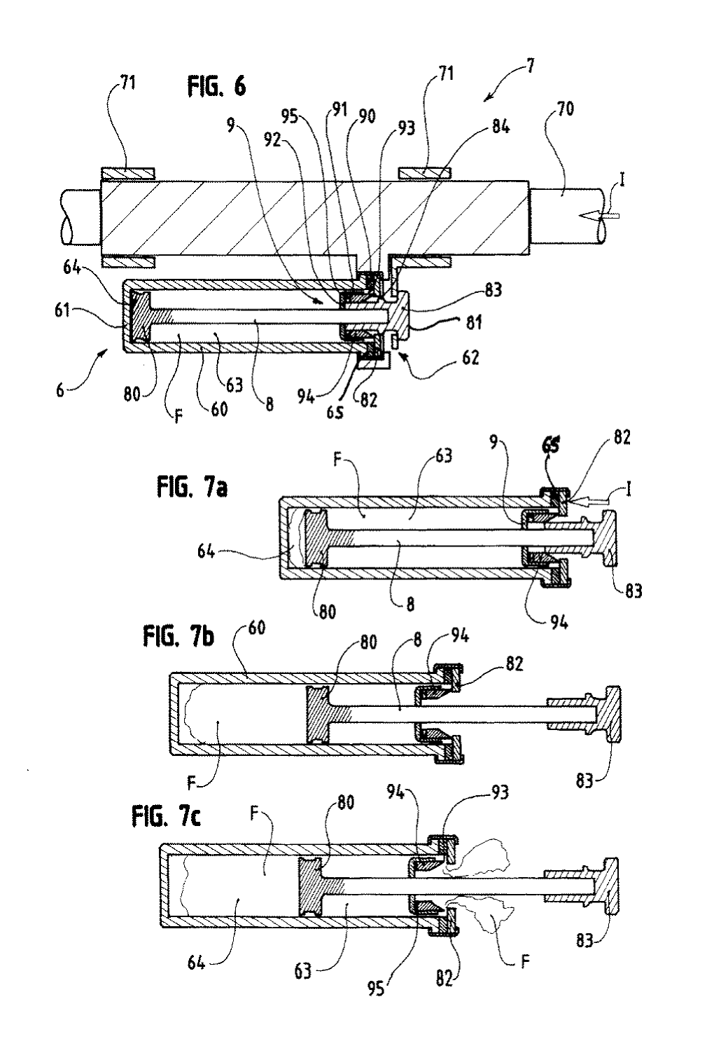

When referring also to FIGS. 7a, 7b and 7c, one can understand the operation of the device 6. At the time of an impact I onto the steering wheel, the latter is transmitted to the body 60 through the steering column 70, which is inserted, while the supports 71 remain fixed and maintain the portion 83 of the part 81.

Under the impact I, the area 84 breaks and the parts 82 and 83 separate from each other, the piston 80 relatively moves in the body 60 while compressing the hydraulic fluid F in the first chamber 63, while the escape allows the filling of the second chamber 64.

When the deceleration of the body 60 has reached a certain level, the element 94 continues its impetus so as to de-obstruct the holes 93 and to authorize an escape of hydraulic fluid F towards the outside, thus reducing the pressure in first chamber 63, and therefore the deceleration.

One thus achieves a power-assisted damping of the retraction of the steering column, which provides the same level of safety to all drivers, irrespective of their stoutness.

It should be noted that according to a variant of the device 6, applied to a system of power-control of a steering column or to another system, the piston 80 is designed tight or nearly tight, so that there is no escape towards the second chamber, and that this escape occurs only towards the outside.

From the point of view construction, irrespective of the embodiment involved, the various elements are made out of usually used materials such as metals, but also plastics.

1. Damping device with power-assisted deceleration, for use in the field of the hydraulic shock absorbers, said damping device comprising:
a sealed body filled with hydraulic fluid;
a piston mounted in said sealed body and made integral with a rod axially moveable out of said sealed body, said rod and said sealed body being arranged so that a strike against one of, said rod or said sealed body, while said rod or said sealed body not being struck is integral with a support, causing axial displacement of said piston and compression of said hydraulic fluids in a chamber;
a flow means allowing said hydraulic fluid to be released from said chamber; and
an element being axially moveable inside said sealed body and forming a check valve for closing said flow means when pushed back in a direction opposite to that of an impact by an elastic means, said element being subjected to initial speed of said impact and having a displacement dependent upon mass thereof and compressive strength of said elastic means.

2. Device according to claim 1, wherein said piston defines two chambers in said sealed body, said two chambers being a first compression chamber for the fluid and a second chamber for collecting the hydraulic fluid coming from said first chamber and proceeding from an escape provided for at a level of said piston.

3. Device according to claim 2, wherein said sealed body has a portion with decreasing transverse dimensions defining said first compression chamber, said decreasing in a direction of displacement of said piston during the compression of said first compression chamber so as to create a narrowing.

4. Device according to claim 1, wherein said element forming a check valve has an annular or similar form, said element being inserted onto or into a part of a globally tubular shape, the shape having a means for said hydraulic fluid to flow out of said first compression chamber and having edges, one of said edges coming into contact with a portion of the sealed body to form a seat of said check valve.

5. Device according to claim 4, wherein said one of said edge forms a check valve, coming into contact with a seat and has, on a face opposite a seal of said flow means, a chamfer conferring to said edge a whistle-like profile.

6. Device according to claim 4, wherein said seat is comprised of a shoulder resulting from a difference in level of a part with a globally tubular shape on or in which is inserted the movable element forming a check valve.

7. Device according to claim 4, wherein said flow means is comprised of holes provided for, in a peripheral groove, a part of a globally tubular shape on a side of evolving the movable element forming a check valve.

8. Device according to claim 2, wherein said flow means are associated with means to transfer the fluid flown out into the second chamber.

9. Device according to claim 2, wherein said flow means are arranged at a level of said piston.

10. Devices according to claim 9, wherein said piston comprises openings on a side of the second compression chamber and peripherally openings on a side of the first compression chamber, said peripherally openings being sealed by a movable element forming a check valve and pushed back by an elastic means in a direction opposite to insertion of said piston into said compression chamber.

11. Device according to claim 1, wherein said flow means are arranged at a level of said sealed body.

12. Device according to claim 11, wherein said tubular body contains a tubular jacket accommodating said piston and having ends formed so to allow a communication of peripheral space with an interior of said tubular jacket, forming said flow means on one side, the movable element being slideably guided and forming a check valve (3).

13. Devices according to 1, wherein said sealed body is formed of a tubular jacket filled with hydraulic fluid, limited, on one side, by a bottom and by a flange through which passes a rode provided at an end thereof, being internal to said sealed body with a piston defining, with said flask, said first compression chamber.

14. Device according to claim 13, wherein said flanged comprises two parts crimped onto the sealed body, a first part being comprised of a cylinder head incorporating said flow means and a part of a globally tubular shape containing the movable element forming a check valve, a second part forming a seat of said check valve.

15. Device according to claim 14, wherein said second part comprises two portions, said two portions being a peripheral portion formed of a disc and a central portion made integral with an end of said rod, said two portions being connected by an area of lower resistance aimed at breaking under a certain tensile force.

16. The device according to claim 13, said device damping retractable steering column of a motor vehicle, said sealed body being integral with a portion of the steering column movable with respect to the vehicle, said rod being made integral with said vehicle, displacement of said portion causing said rode to be extracted out of said sealed body and compression said piston of the first compression.
